(19) United States
(12) Patent Application Publication
(10) Pub. No.: US 2020/0131013 A1
(43) Pub. Date: Apr. 30, 2020

(54) FORKLIFT DEBRIS SHIELD ASSEMBLY

(71) Applicant: Kurt Nails, SR., St. Louis, MO (US)

(72) Inventor: Kurt Nails, SR., St. Louis, MO (US)

(21) Appl. No.: 16/176,368

(22) Filed: Oct. 31, 2018

(51) Int. Cl. B66F 9/075

(52) U.S. Cl. CPC B66F 9/07545

(57) ABSTRACT

A forklift debris shield assembly for protecting a driver of an industrial vehicle from falling objects includes an industrial vehicle that is driven for lifting and transporting objects. The industrial vehicle has a driver cage thereon and a shield is coupled to the driver cage. The shield is comprised of a rigid material to protect a driver of the industrial vehicle from falling objects. Additionally, the shield is comprised of a translucent material to facilitate the driver to see through the shield.

### CROSS-REFERENCE TO RELATED APPLICATIONS

### Statement Regarding Federally Sponsored Research or Development

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to debris shield devices and more particularly pertains to a new debris shield device for protecting a driver of an industrial vehicle from falling objects.

### BRIEF SUMMARY OF THE INVENTION

An embodiment of the disclosure meets the needs presented above by generally comprising an industrial vehicle that is driven for lifting and transporting objects. The industrial vehicle has a driver cage thereon and a shield is coupled to the driver cage. The shield is comprised of a rigid material to protect a driver of the industrial vehicle from falling objects. Additionally, the shield is comprised of a translucent material to facilitate the driver to see through the shield.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a forklift debris shield assembly according to an embodiment of the disclosure.

FIG. 2 is an exploded perspective view of an embodiment of the disclosure.

FIG. 3 is a left side exploded view of an embodiment of the disclosure.

FIG. 4 is a top view of an embodiment of the disclosure.

### DETAILED DESCRIPTION OF THE INVENTION

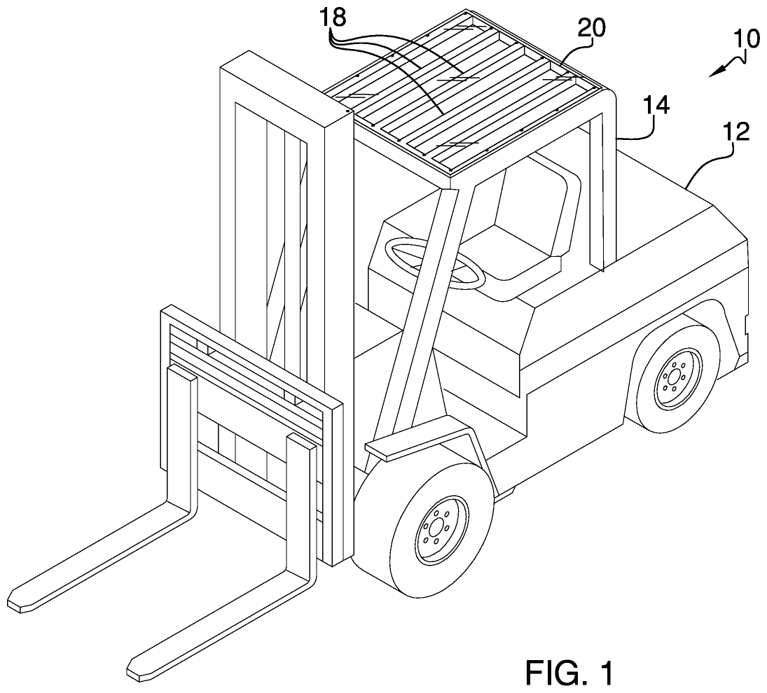

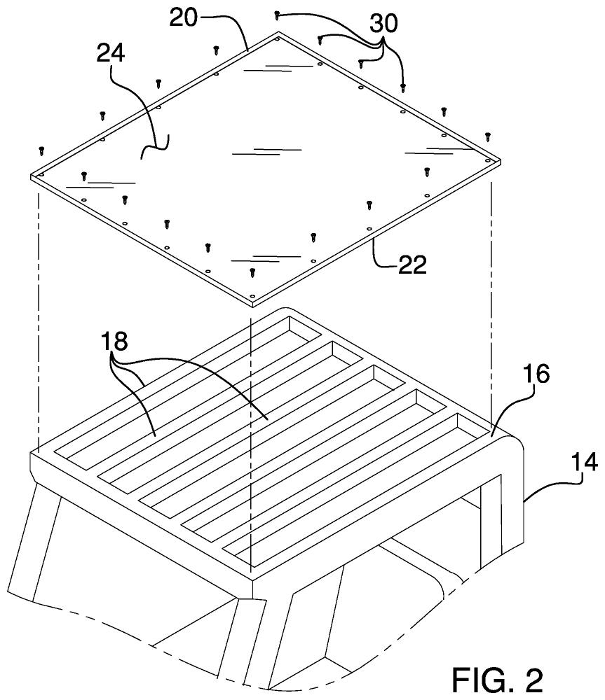

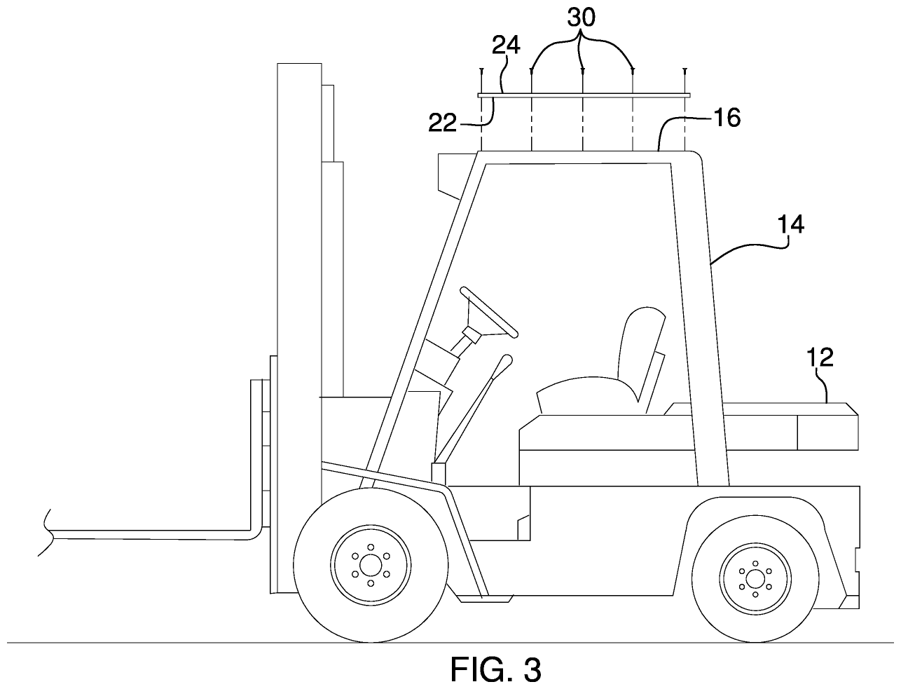

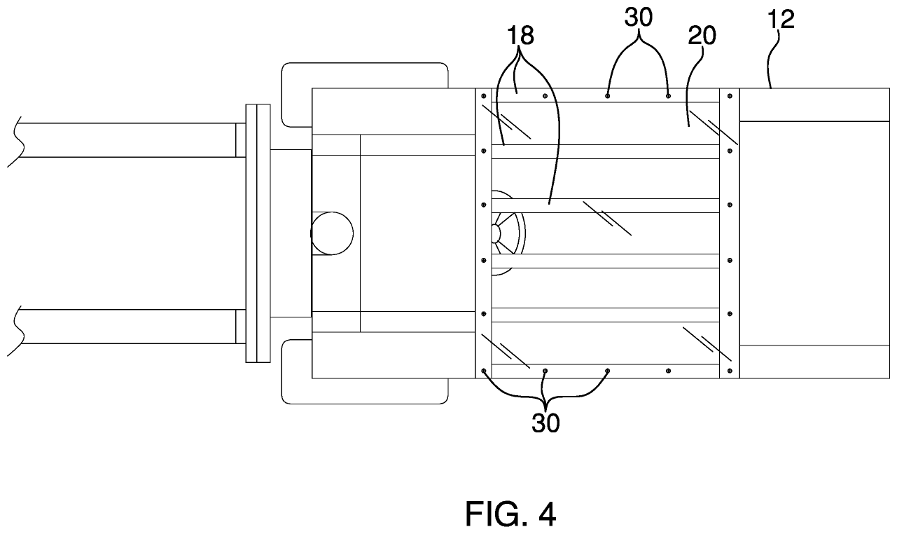

With reference now to the drawings, and in particular to FIGS. 1 through 4 thereof, a new debris shield device embodying the principles and concepts of an embodiment of the disclosure and generally designated by the reference numeral 10 will be described.

As best illustrated in FIGS. 1 through 4, the forklift debris shield assembly 10 generally comprises an industrial vehicle 12 that may be driven for lifting and transporting objects. The industrial vehicle 12 may be a forklift, a lift truck or any other motorized industrial vehicle 12 that has hydraulic lifting capabilities. The industrial vehicle 12 has a driver cage 14 thereon, the driver cage 14 has a top side 16, and the top side 16 comprises a plurality of members 18 that are spaced apart from each other.

A shield 20 is provided and the shield 20 is coupled to the driver cage 14. The shield 20 is comprised of a rigid material to protect a driver of the industrial vehicle 12 from falling objects. Additionally, the shield 20 protects the driver from precipitation, dust and other contaminants that could conceivably fall through the driver cage 14. The shield 20 is comprised of a translucent material to facilitate the driver to see through the shield 20.

The shield 20 has a bottom surface 22, a top surface 24 and a perimeter edge 26 extending therebetween. The bottom surface 22 rests on each of the members 18 having the perimeter edge 26 being coextensive with a perimeter 28 of the top side 16 of the cage. A plurality of fasteners 30 is provided and each of the fasteners 30 extends through the shield 20 and engages the driver cage 14 for retaining the shield 20 on the driver cage 14. Each of the fasteners 30 extends through the top 24 and bottom 22 surfaces of the shield 20 and engages a respective one of the members 18. Moreover, the fasteners 30 are spaced apart from each other and are distributed around the perimeter edge 26 of the shield 20. Each of the fasteners 30 may be screws, zip ties or any other selectively releasable fastener.

In use, the shield 20 is positioned on the top side 16 of the driver cage 14 and each of the fasteners 30 is extended through the shield 20 and each of the fasteners 30 engages the driver cage 14. Thus, the driver is protected from falling objects when the industrial vehicle 12 is being employed for lifting and transporting objects. Moreover, the translucent quality of the shield 20 permits the driver to see through the shield 20 when the industrial vehicle 12 is driven. In this way the shield 20 does not limit the driver's ability the position the objects at an elevated position when the objects are being transported and lifted. Additionally, the shield 20 enhances the driver's comfort with respect to protecting the driver from precipitation, dust and other contaminants that could otherwise pass through the driver cage 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A forklift debris shield assembly being configured to protect a driver of a forklift from falling debris, said assembly comprising:
an industrial vehicle being driven for lifting and transporting objects, said industrial vehicle having a driver cage thereon; and
a shield being coupled to said driver cage, said shield being comprised of a rigid material wherein said shield is configured to protect a driver of said industrial vehicle from falling objects, said shield being comprised of a translucent material wherein said shield is configured to facilitate the driver to see through said shield.

2. The assembly according to claim 1, wherein:
said driver cage has a top side, said top side comprising a plurality of members being spaced apart from each other;
said shield has a bottom surface, a top surface and a perimeter edge extending therebetween, said bottom surface resting on each of said members having said perimeter edge being coextensive with a perimeter of said top side of said cage.

3. The assembly according to claim 1, further comprising a plurality of fasteners, each of said fasteners extending through said shield and engaging said driver cage for retaining said shield on said driver cage.

4. The assembly according to claim 3, wherein:
said driver cage has a top side, said top side comprising a plurality of members being spaced apart from each other;
said shield has a bottom surface, a top surface and a perimeter edge extending therebetween, said bottom surface resting on each of said members having said perimeter edge being coextensive with a perimeter of said top side of said cage; and
each of said fasteners extends through said top and bottom surfaces of said shield and engaging a respective one of said members, said fasteners being spaced apart from each other and being distributed around said perimeter edge of said shield.

5. A forklift debris shield assembly being configured to protect a driver of a forklift from falling debris, said assembly comprising:
an industrial vehicle being driven for lifting and transporting objects, said industrial vehicle having a driver cage thereon, said driver cage having a top side, said top side comprising a plurality of members being spaced apart from each other;
a shield being coupled to said driver cage, said shield being comprised of a rigid material wherein said shield is configured to protect a driver of said industrial vehicle from falling objects, said shield being comprised of a translucent material wherein said shield is configured to facilitate the driver to see through said shield, said shield having a bottom surface, a top surface and a perimeter edge extending therebetween, said bottom surface resting on each of said members having said perimeter edge being coextensive with a perimeter of said top side of said cage; and
a plurality of fasteners, each of said fasteners extending through said shield and engaging said driver cage for retaining said shield on said driver cage, each of said fasteners extending through said top and bottom surfaces of said shield and engaging a respective one of said members, said fasteners being spaced apart from each other and being distributed around said perimeter edge of said shield.
